(19) United States
(12) Patent Application Publication
(10) Pub. No.: US 2007/0005248 A1
(43) Pub. Date: Jan. 4, 2007

(54) Data reconstruction in link-based interconnects

(75) Inventors: Gregory S. Averill, Fort Collins, CO (US); Padmashree K. Apparao, Portland, OR (US)

Correspondence Address: RYDER IP LAW;C/O INTELLEVATE, P. O. BOX 52050, MINNEAPOLIS, MN, 55402, US

(73) Assignee: Intel Corporation

(21) Appl. No.: 11/171,001

(22) Filed: Jun. 29, 2005

(51) Int. Cl. G06F 17/10

(52) U.S. Cl. 701/301

(57) ABSTRACT

In general, in one aspect, the disclosure describes an apparatus including a receiver to receive a data packet as a plurality of data vectors over an interconnect. The interconnect includes a plurality of lanes. The apparatus also includes an error detector to detect errors in the data vectors. A buffer is used to store the data vectors received error free. A processor requests a retransmission of the packet if data vectors making up the packet are received with errors. The retransmission of the data packet includes at least a subset of the data vectors being transmitted on different lanes. An assembler reconstructs the data packet once the plurality of data vectors making up the data packet are stored in the buffer. The data packet can be reconstructed even if it was never sent correctly in a single transmission.

### BACKGROUND

High-speed link-based interconnects transfer large amounts of data at high speeds from one location (a transmitter) to another (a receiver). The data being transmitted over the links may have multiple parameters (speeds, protocols, size, quality of service). In order to meet the high-speed requirements, the transmitter divides the data (e.g., a packet) into smaller components (e.g., bits, bytes, segments) and transmits the smaller components over multiple lanes (channels). It may take multiple cycles to transmit the packet over the lanes. After transmitting the smaller components one or more parity bits (or bits of some more complex error coding scheme) may be transmitted on each lane for error checking. The receiver receives the smaller components from each lane and stores them until the data packet is received in full. The receiver utilizes the parity bits to determine if the data received on each lane (e.g., data vector) or across lanes (for more complex error detection schemes) was transmitted correctly. If there are no errors in any of the data vectors the packet is put back together. If there were errors in one or more of the lanes, the erroneous data vectors (and possibly all for the data vectors associated with the data packet) may be discarded and the data packet may be retransmitted. The retransmission of the packet is normally retried a predefined number of times.

Errors in data vectors may be caused by either transient or permanent failures in the lanes that transmitted them. Transient failures occur intermittently where permanent errors occur more regularly/consistently or constantly. The number of errors per lane is monitored and if a certain threshold (or one of several thresholds) is achieved the lane may be deemed to have a permanent failure. When errors occur on a lane (or lanes) but a threshold number of errors have not been surpassed (transient failures), the data packet is retransmitted as it is assumed that the error will not be maintained and a successful retry can be achieved. If a certain lane (or lanes) surpasses a threshold (permanent failures) the lane (or a plurality of lanes) may be shut down while the lane is fixed. When a lane or lanes are shut down for repair, the bandwidth available is reduced accordingly. It is not uncommon to shut down half of the available lanes (e.g., 4 out of 8) in order to repair or replace a faulty lane or lanes.

If a transient failure is maintained for several cycles, the same data packet may be unsuccessfully transmitted several times with the same data vector being received in error each time. As the speed of data transmission continues to increase, it is likely that the number of errors (whether permanent or transient) experienced will increase. Retransmitting data on faulty lanes or reducing the bandwidth available in order to correct faulty lanes degrade performance.

### BRIEF DESCRIPTION OF THE DRAWINGS

The features and advantages of the various embodiments will become apparent from the following detailed description in which:

FIG. 1 illustrates an example system using a link based interconnect, according to one embodiment;

FIG. 2 illustrates an example transmission scenario for a data packet over a link-based interconnect having intermittent failures, according to one embodiment;

FIG. 3A illustrates an example transmission scenario for a data packet over a link-based interconnect having intermittent failures on different lanes, according tone embodiment;

FIG. 3B illustrates an example transmission scenario for a data packet over a link-based interconnect having sustained intermittent/permanent failures, according tone embodiment;

FIG. 4 illustrates an example rotating retransmission scenario for a data packet over a link-based interconnect, according tone embodiment;

FIG. 5 illustrates an example link-based interconnect having multiple lane failures, according tone embodiment;

FIG. 6 illustrates an example transmitter used for link-based interconnects, according to one embodiment;

FIG. 7 illustrates an example receiver used for link-based interconnects, according to one embodiment;

FIG. 8 illustrates an example flowchart for transmitting/retransmitting data over a link-based interconnect, according to one embodiment; and

FIG. 9 illustrates an example store-and-forward device with serial links, according to one embodiment.

### DETAILED DESCRIPTION

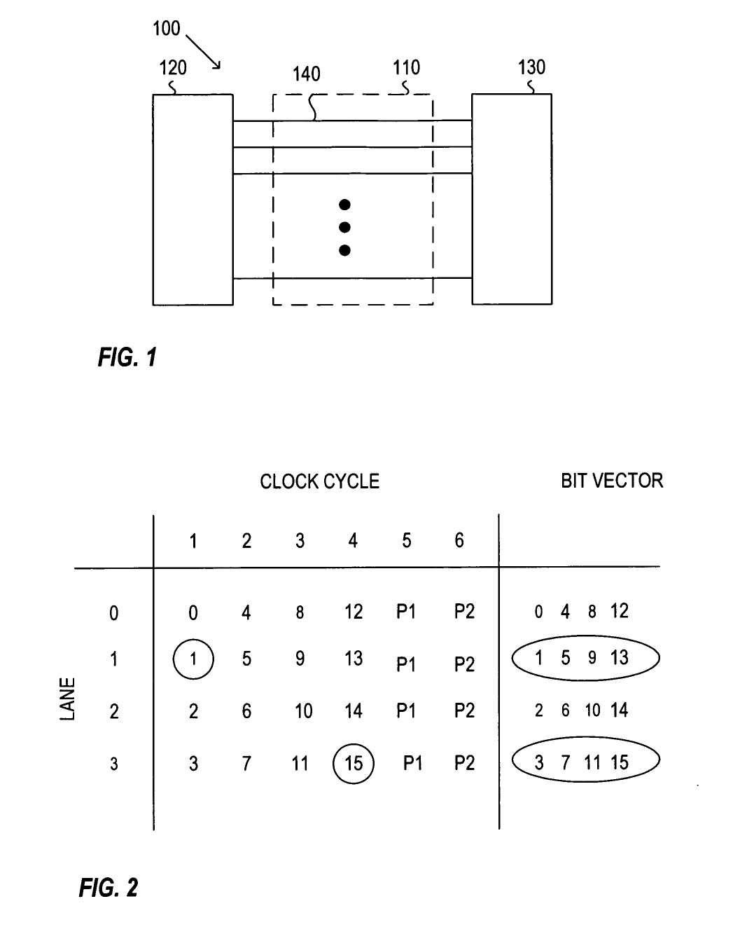

FIG. 1 illustrates an example system 100 utilizing a link-based interconnect 110 to connect a first device (transmitter) 120 to a second device (receiver) 130. The interconnect 110 includes a plurality of lanes (channels) 140 connecting the transmitter 120 to the receiver 130. Data (packets) being transmitted from the transmitter 120 to the receiver 130 are striped across the lanes. Striping is the process of breaking a large packet into smaller pieces (chunks) and transmitting the smaller pieces across multiple lanes. The smaller pieces may be bits, segments, bytes, or words. For example, an 8-byte packet may be divided into 64 1-bit chunks, 16 4-bit chucks, 8 1-byte chunks, or 2 4-byte chunks (words).

If an 8 lane interconnect 110 was utilized to transmit the 8-byte packet 1 bit per lane per cycle, 1 byte would be transmitted each cycle and it would take 8 cycles to transmit the entire packet. Error checking schemes may be transmitted after the data is transmitted. For example, the error detection scheme may be transmitted during clock cycles 9 and 10. The data received on a lane forming a data vector (e.g., bit vector) for the lane. In the above example, a bit vector would consist of 8 bits of data and 2 error checking bits.

The error checking scheme may be parity bits, or may be a more complex error checking scheme that may be calculated over multiple lanes or for the packet (e.g., cyclic redundancy codes (CRCs)).

If the 8 lane interconnect 110 was utilized to transmit the 8-byte packet 4-bits per lane per cycle, 4 bytes would be transmitted each cycle and it would take 2 cycles to transmit the entire packet. If the 8 lane interconnect 110 was utilized to transmit the 8-byte packet 1 byte per lane per cycle, 8 bytes would be transmitted each cycle and it would take 1 cycle to transmit the entire packet. In one embodiment, the error checking scheme (e.g., parity bits) may be transmitted in a cycle after the data is transmitted (e.g., third cycle, second cycle). Alternatively, the error checking scheme may be appended to the data bits and transmitted each clock cycle. If the error checking scheme is transmitted each clock cycle it would be possible to check the data received each clock cycle rather than waiting for a complete data vector for the channel. If the error checking scheme is included with the data, the number of bits being transmitted in the cycle either needs to be expanded (e.g., 10 total bits, 8 data bits and 2 parity bits) or the number of data bits needs to be reduced by the number of parity bits (e.g., 8 total bits, 6 data bits and 2 parity bits).

The receiver 130 receives the data vectors making up a data packet. The receiver 130 may include a buffer to hold a received data packet organized by the data vectors received per lane. The receiver 120 may use the error checking scheme to determine if the data vectors were transmitted and received correctly or were received in error. If one or more of the data vectors were received in error the data packet will need to be retransmitted. The receiver 130 may request the transmitter 120 to retry transmitting the packet.

According to one embodiment, the receiver 130 may discard the data vectors making up the packet if one or more of the data vectors contained an error. In order for a packet to be received and reassembled, all the data vectors making up the packet have to be received correctly. If intermittent failures occur on at least one lane during transmission of a data packet, the data packet would not be received in full or capable of being reassembled.

FIG. 2 illustrates an example scenario of a data packet being transmitted over a link-based interconnect having intermittent failures. The packet is 2 bytes and the interconnect includes 4 lanes (lanes 0-3). If 1 bit is transmitted per lane per clock cycle it would take 4 clock cycles (1-4) to transmit the packet (bits 0-15). The bits may be transmitted in order over the lanes. For example, bits 0-3 over lanes 0-3 respectively during clock cycle 1, bits 4-7 over lanes 0-3 during clock cycle 2, bits 8-11 during clock cycle 3, and bits 12-15 during clock cycle 4. Parity bits may be added per lane after the transmission of the data (e.g., clock cycles 5 and 6).

The data vector (bit vector) for the lanes are checked for errors using the parity bits, once the packet is received by the receiver 130. If an error occurred during transmission of any of the bits in the bit vector, the bit vector will contain errors that should be detected utilizing the parity bits. As illustrated, bit 1 that was transmitted on lane 1 during the first clock cycle and bit 15 that was transmitted on lane 3 during the fourth clock cycle were erroneously transmitted, so that the bit vector for lanes 1 and 3 would be in error.

The bits and bit vectors are illustrated by bit number for ease of understanding and discussion. The bits would be 0s or 1s and the bit vectors would be a series of 0s and/or 1s (4 data bits followed by 2 parity bits). For example, the bit vector for lane 0 may be 0010_{—}10, where the first 4 bits are the data that will be used to reassemble the packet and the last two bits are the parity bits used to determine if there are any errors in the bit vector. The “_” is simply to easily distinguish the data and parity bits.

FIG. 2 was described with respect to a single bit being transmitted each cycle. As noted above the various embodiments described herein are not limited to single bit transmission per cycle. Rather, the data could be transmitted by segments (e.g., multiple bits) or bytes where the number would represent the segment number or the byte number and the data vector would be the combination of segments and/or bytes transmitted over a particular lane. For example, if 4 bits were transmitted each cycle followed by a single 4 bit parity sequence in cycle 5 (no cycle six), the data vector would consist of a total of 2 bytes of data and ½ byte of parity (e.g., 0101_{—}1111_{—}0000_{—}1010_{—}1100). The “_” is simply to easily distinguish the data and/or parity bits that were transmitted during each cycle. In this example, the packet would be 8 bytes.

It should also be noted that the parity bits (or other error detection scheme) may be included in the segment transmitted each clock cycle. When discussing different embodiments in the remainder of the disclosure, we will discuss with regard to single bits being transmitted each cycle and each lane transmitting a bit vector (the bits transmitted via the lane) for ease of understanding. However, the various embodiments are not limited thereby.

According to one embodiment, when one or more data vectors that are part of a packet are received erroneously, the receiver may discard the packet and request retransmission of the packet. Once, a packet is received error free it will be assembled and processed. The receiver may request up to a predetermined number of retries to receive the packet error free.

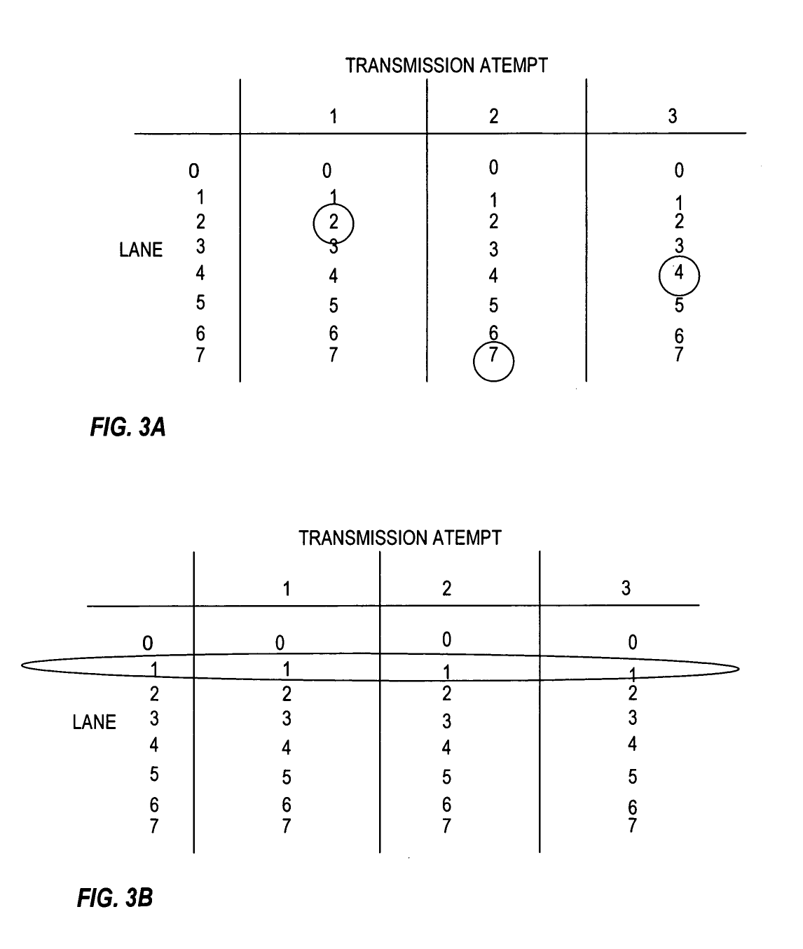

FIGS. 3A-B illustrate example transmission/retransmissions of packets over an interconnect. The individual clock cycles, the chunks of data sent per cycle, and the error detection schemes transmitted that may make up the transmission of the packet are not shown. Additionally, for simplicity only the data vector numbers are shown. As described above, the data vectors would be some combination of bits.

FIG. 3A illustrates an example scenario of the transmission of a data packet over a link-based interconnect having intermittent failures on different lanes. During the first transmission attempt, bit vector 2 transmitted on lane 2 has errors so that the packet will not be able to be reassembled and retransmission will be requested. During the second transmission attempt, bit vector 7 transmitted on lane 7 has errors so that the packet will not be able to be reassembled and retransmission will be requested. During the third transmission attempt, bit vector 4 transmitted on lane 4 has errors so that the packet will not be able to be reassembled. As illustrated the transmission of the packet failed three times due to intermittent failures on different lanes. During each transmission attempt 7 of the 8 bit vectors were received error free. However, the entire packet was never received error free.

According to one embodiment, the receiver 130 maintains the bit vectors that were received correctly for each packet and after all of the data vectors have been received correctly reassembles the data packet. Using the example of FIG. 3A, during the first transmission of the data packet 7 of the 8 bit vectors making up the packet would be received correctly (vector 2 would be discarded as it was received in error). During the second transmission, the faulty bit vector (vector 2) is received without error and the packet could then be reassembled.

According to one embodiment, the transmitter 120 will retransmit the plurality of data vectors making up the packet over the same lanes. If there is a permanent failure (or a temporary failure that is maintained for several data transfer cycles) in one or more of the lanes 140 retransmitting the packet, the packet may continually be received in error and discarded because the data vector(s) being received via the lane(s) 140 in error will continue to have errors.

FIG. 3B illustrates an example scenario of the transmission of a data packet over a link-based interconnect having sustained intermittent/permanent failures. The packet is divided into 8 data vectors that are transmitted over 8 lanes during a data transfer cycle. During each transmission cycle the bit vector transmitted over lane 1 is received in error so that the data packet can not be reassembled. The packet is likely to be retransmitted a predetermined number of times (e.g., 3) before the packet is discarded. The receiver 130 may monitor the number of failures on the particular lanes and may flag the lane as inoperative if a threshold number of failures are surpassed. If the lane is flagged as inoperative it may be shut down thus reducing the bandwidth available and degrading the interconnect. As discussed earlier, it is possible that multiple lanes (e.g., half) are shut down when a particular lane or lanes is declared inoperative. The inoperative lanes(s) may be eligible for repair or replacement.

According to one embodiment, the transmitter 120 may rotate the order in which the data vectors making up a packet are retransmitted after a failure is detected on a lane. The rotation may simply be to rotate the bit vectors in either direction (e.g., one lane forward). Rotating the bit vectors enables a complete data packet to be received if an intermittent failure persists on a single lane or if the lane has a permanent failure.

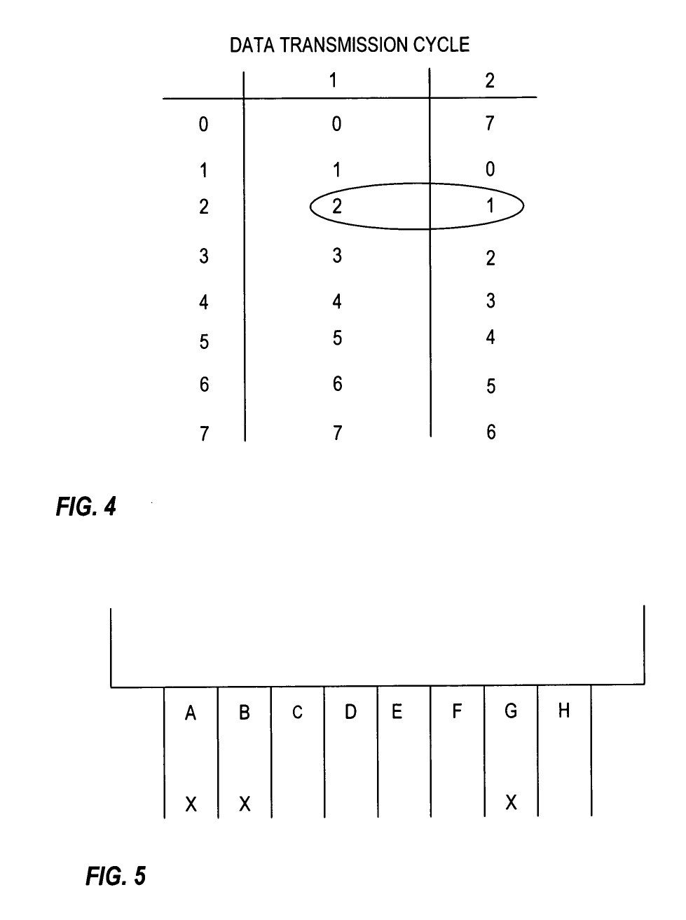

FIG. 4 illustrates an example scenario of a rotating transmission of bit vectors in a data packet over a link-based interconnect having sustained intermittent/permanent failures. The packet is transmitted over 8 lanes. During each transmission the bit vector transmitted over lane 2 is received in error. During the first transmission bit vector 2 is received in error over lane 2. During the second transmission each of the bit vectors is shifted forwarded a lane so that bit vector 1 is receiver in error on lane 2 and bit vector 2 is received correctly on lane 3. The receiver has now received each of the bit vectors in the packet after two data transmissions of the packet even though there was a sustained error on one of the lanes.

According to one embodiment, the rotation of the data vectors may be agreed to in advance so that when a particular bit vector is received in error (an error occurred on a particular lane) the transmitter 120 automatically knows to do a certain rotation once the receiver 130 informs the transmitter 120 that the data packet was received with an error (lane error occurred on may not be necessary). For example, if an error is detected during transmission of the packet the data vectors are rotated one lane forward for retransmission.

According to another embodiment, the determination of the rotation may be made after the error is detected. The determination may be made by the receiver 130, as the receiver 130 will know which bit vector (lane) failed for the current packet. Moreover, the receiver 130 may track which lanes have failed in the past and may make a decision regarding rotation based on the current failures as well as historical failures. Alternatively, the decision of how to rotate the bit vectors for retransmission may be made by the transmitter 120. In order for the transmitter 120 to make the decision it will have to be apprised about which lane failed and possibility be apprised about previous failures. The decision may be made by both the receiver 130 and the transmitter 120 in conjunction with one another, with each providing some analysis to the decision. However the decision is made, both the transmitter 120 and the receiver 130 need to be aware of what the rotation is going to be so that the bit vectors are transmitted and received correctly and so that the packet can be accurately reassembled at the receiver 130.

The determination of what rotation to make may be simple or may be complex. For example, the rotation may be simply one lane in either direction or may be multiple lanes in either direction. The determination of what rotation to make may depend on the lane that failed and previous failures of the various lanes. For example, if lane 2 failed this time and lane 3 has a history of intermittent failures a decision could be made to rotate one lane backwards or two lanes forward so that the faulty data vector is transmitted on lane 1 or lane 4 and not lanes 2 or 3 for the retransmission.

According to one embodiment, rather than a rotation a swap may be made where the bit vector transmitted over the faulty lane may be retransmitted on a lane that transmitted a valid bit vector and the valid bit vector may be retransmitted on the faulty lane while the other lanes are maintained the same. For example if lane 3 failed during transmission of a packet, the bit vector transmitted on lane 3 may be retransmitted on lane 7 and the bit vector transmitted on lane 7 may be retransmitted on lane 3 with the other lanes retransmitting the same bit vectors. The decision of which lane to swap may be predetermined (e.g., lanes 1 and 2 swap, lanes 3 and 4 swap) or may be made based on various parameters including previous lane failures.

The rotation or swapping has been discussed with respect to single lane failures but is clearly not limited thereto. The same type of rotation or swapping could occur if multiple lane failures were detected. The rotation or swapping may be predefined or may be based on the circumstances surrounding the failure. With multiple lane failures, predetermined rotations or swaps become more complicated. For example, if two consecutive lanes failed and the predetermined rotation was one lane, the error in the first lane would be retransmitted on the second lane (possibly increasing the chance of another failure in the transmission of the packet if the second lane failed again).

If the rotation is based on the circumstances, the rotation should be made in a manner that reduces the number of retries necessary to assemble a complete packet. An algorithm may be used to determine how to rotate the vectors. The algorithm may be simple or it may be complex. A simple algorithm may be able to process certain types of multiple failures so that a single retry transmits failed vectors over non-failed lanes. For example if two consecutive lanes failed, the simple algorithm could rotate the data vectors two lanes. Likewise if multiple failures occurred every other lane, a simple rotation of one lane would result in a retransmission of the failed vectors on non-failed lanes.

FIG. 5 illustrates an exemplary interconnect having multiple failed lanes. The interconnect has 8 lanes labeled A-H with lanes A, B and G having failures. As two consecutive lanes are failed a single lane rotation would result in a retransmission of the failed vector from lane A being retransmitted over failed lane B. A two-lane rotation would result in the retransmission of faulty data vectors from lanes A and B over error-free lanes C and D. However, a double rotation would result in faulty data vector from lane G being retransmitted on faulty lane A. The double rotation takes care of two of the three errors. A second retransmission of two lanes would result in the faulty data vector from lane G and then lane A being retransmitted over error-free lane C. The simple algorithm enabled the packet to be transmitted error free with three transmissions (two retransmissions).

A complex algorithm may be able to analyze multiple failures spread across the interconnect and determine optimum rotation to have fewest retries to transmit complete packet. For example, a complex algorithm may be able to analyze the three failures of FIG. 5 and determine that by doing a rotation of four lanes the failed vectors can be transmitted over an error-free lane with one retransmission. The faulty data vectors transmitted over lanes A, B and G would be retransmitted over lanes E, F and C respectively.

The algorithm for determining the desired rotation for retransmission of a packet having multiple failed vectors may also take into account previous failures that have occurred. For example, if it is known that a certain lane has continually failed though it did not fail on the transmission of the specific packet the algorithm may avoid retransmitting on that lane.

According to one embodiment, a swap may be performed for multiple failures rather than a rotation. The three failures of FIG. 5 (lanes A, B, and G) may be swapped with any three of the five lanes that correctly transmitted data vectors while the other two lanes may stay the same. For example, lanes A and C, B and D, and G and H may swap while lanes E and F remain the same. The swapping may take into account previous failures that have been tracked. For example, if lanes C and D previously had a large amount of failures those lanes may be maintained the same and lanes E and F may instead swap with lanes A and B.

The rotation or swapping of lanes enables data to be transmitted even if a lane or lanes have permanent failures as the data received in error on the first transmission can be rotated or swapped around the faulty lanes. Moreover, data can continue to be transmitted while a lane is repaired or replaced without the need for taking down multiple lanes (e.g., half) while the repair or replacement is performed. Without the rotation or swapping permanent failures would need top be corrected at which point the bandwidth of the system may be cut in half. Failures on the remaining half would further reduce bandwidth as additional retransmissions would be required. For example, in FIG. 5 the rotation/swapping scenario enables the system to continue performing with only five lanes by rotating the data vectors over those 5 lanes. Without the rotation/swapping embodiments, the first 4 lanes may need to be taken off line to replace/repair lanes A and B leaving only 3 error free lanes to transmit data and the possibility of multiple retransmissions being necessary due to errors on lane G.

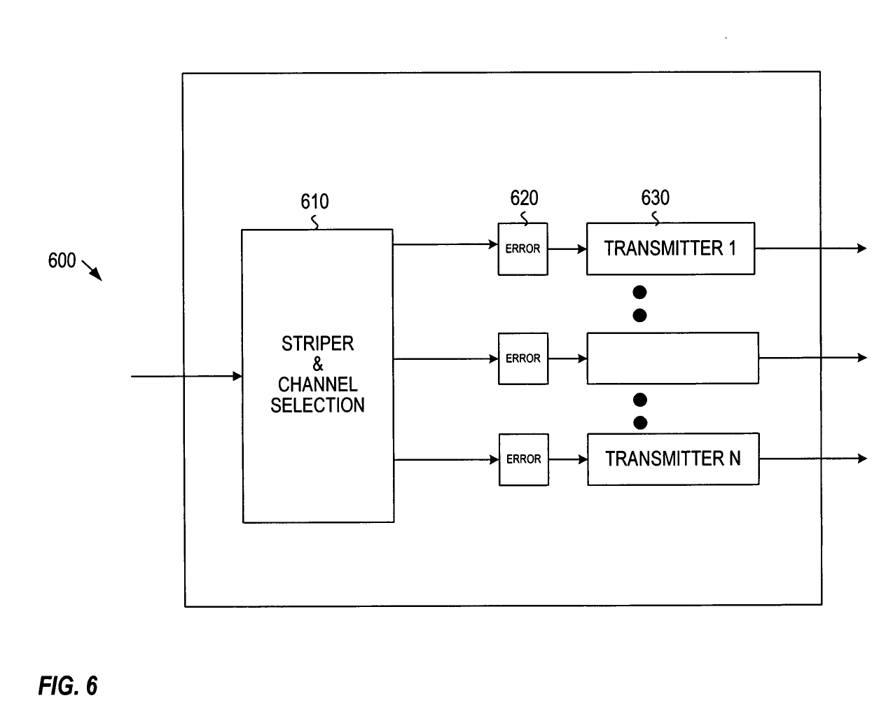

FIG. 6 illustrates an exemplary transmitter (transmission module) 600 for transmitting a packet over an interconnect. The transmitter 600 may include a stripper 610, a plurality of error modules 620, and a plurality of lane transmitters 630. The stripper 610 receives a packet and divides the packet into a plurality of smaller pieces (e.g., bits, segments, bytes) and assigns the smaller pieces to specific lanes (channels) of a plurality of lanes. For example if an 8-byte (64-bit) packet is received, the packet may be divided into eight 1-byte (8-bit) chunks and each chunk may be associated with a specific lane. In this example, only a single clock cycle would be necessary to transmit the packet. If multiple cycles were necessary the data transmitted over each lane would be combined to create a data vector for the lane.

The stripper 610 selects what smaller pieces (and data vectors) are transmitted on what lane. If retransmission of a packet is necessary the data vectors may be transmitted over the same lanes. Alternatively, the transmitter 600 may rotate or swap the data vectors that are transmitted on each lane. The stripper 610 may make the determination about rotating or swapping based on input from a receiver or it may be instructed how to rotate or swap from the receiver or from some other external function that may determine how to rotate or swap based on the results of previous transmissions of the packet.

The error modules 620 add some type of error checking scheme in the form of additional bits to the end of each data vector. The error checking bits may be parity bits, cyclic redundancy code (CRC) bits, or other error checking scenarios. The error checking bits may be transmitted at the end of the data (e.g., during clock cycles 9, 10 if the data was transmitted during cycles 1-8) or may be transmitted with the data in each cycle. The data vectors are the data and error bits transmitted for a lane. The data vector (stripe) for each lane is then provided to an associated lane transmitter 630 for transmitting over the interconnect. There are a total of N transmitters 630, one for each lane.

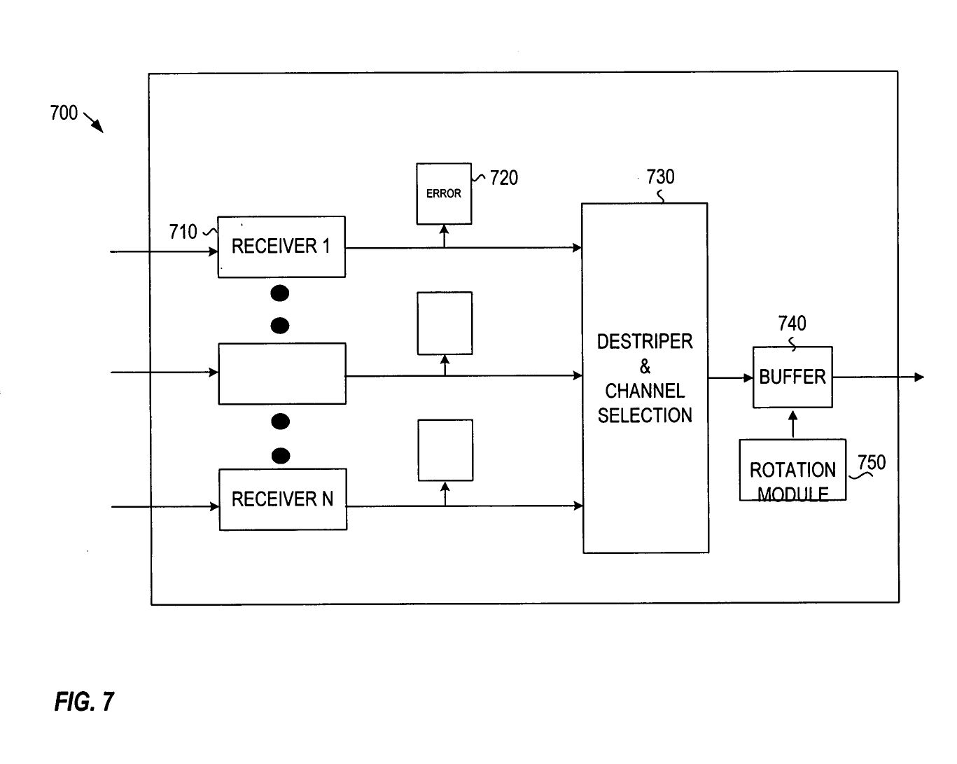

FIG. 7 illustrates an exemplary receiver (receiving module) 700 for receiving a packet over an interconnect. The receiver 700 may includes a plurality of lane receivers 710, a plurality or error checkers 720, and a destriper 730. The line receivers 710 receive and buffer data over the lanes. The error modules 720 check to see if the data received is in error by utilizing the error detection bits. The data vectors are provided to a destriper 730 that takes the data vectors from each lane and reconstructs the packet. The destriper monitors if there was an error in any of the data vectors associated with the packet. If there was an error the data packet needs to be retransmitted. The receiver 700 will notify the transmitter of the failure.

The receiver 700 may also include a buffer 740 that maintains the error-free data vectors for each packet. The buffer 740 may also monitor which lane the erroneous data vector was received on. The receiver 700 may also include a rotation determination module 750 that looks at the errors in the packet and determines how to rotate the data vectors on retransmission in order to limit the number of retries required. The buffer 740 may also record errors in lanes and compare to an error threshold. If the lane exceeds the error threshold it may be configured out of the system until it can be repaired. As previously noted, according to some embodiments an entire half of the available lanes may be deactivated while a repair is done. Shutting down half of the lanes allows for an easy determination of how to transmit the data with reduced bandwidth (send same amount of data over each lane but require twice as many data transmission cycles). The rotation determination module 750 may utilize the error status of each of the lanes in making a determination as to how to rotate or swap the data vectors when the packet is retransmitted.

The transmitter and the receiver were discussed in separate figures as separate devices. As data transmission is likely bidirectional, a transceiver is likely located on each end of an interconnect and can either transmit or receive packets as data vectors over a plurality of lanes.

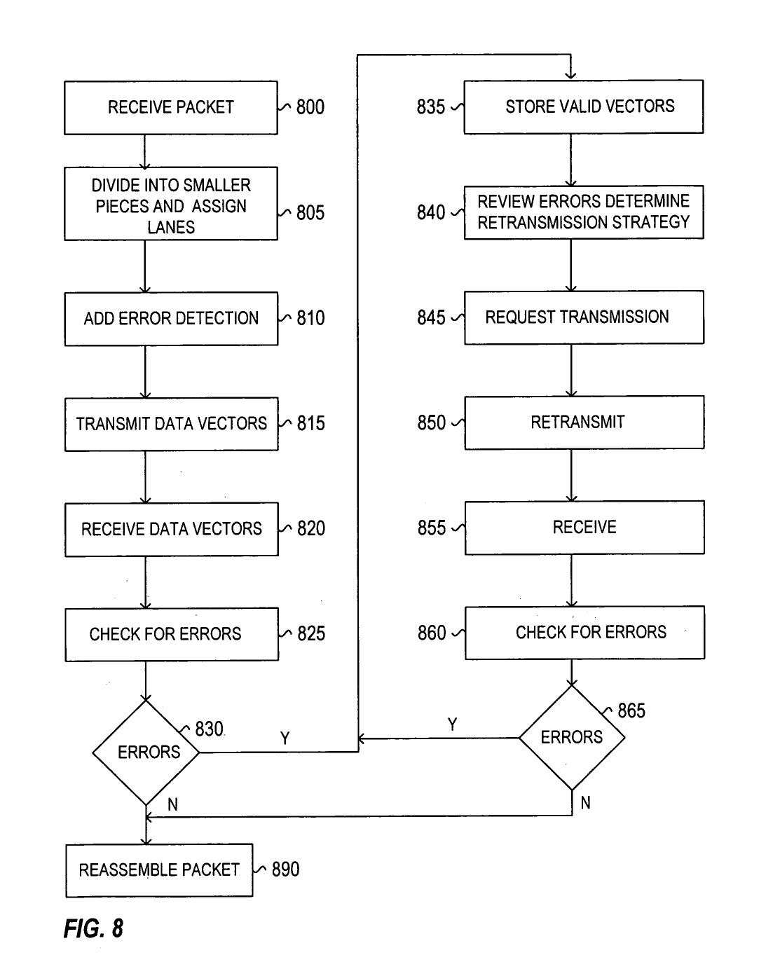

FIG. 8 illustrates an example flow chart for retransmission of packets with errors. Initially a packet to be transmitted over the interconnect is received 800. The packet is divided into a plurality of smaller pieces and the smaller pieces are assigned to lanes 805. The smaller pieces may be a single bit or may be larger but have a maximum size that is smaller than a packet. A data vector is the combination of smaller pieces that are transmitted over a lane. An error detection scheme (e.g., parity bits) is added to the data vectors 810. The data vectors (including the error detection scheme) are transmitted over a plurality of lanes that are part of the interconnect 815. The data vectors are received 820 and are checked for errors 825 using the error detection scheme. A determination is made as to whether there are any faulty data vectors in the packet 830. If there were no faulty data vectors (830 No), the data vectors are reassembled into the packet 890. If there were errors in at least one of the data vectors (830 yes) the valid data vectors are stored 835 and the errors are reviewed in order to determine a retransmission strategy 840. The retransmission strategy may be rotate the data vectors one lane.

Once the transmission strategy is determined a request for retransmission under those parameters is requested 845. The data vectors are then retransmitted in accordance with the retransmission instructions 850. The data vectors are received 855 and checked for errors 860. The data vectors of most importance are those that were previously transmitted in error as the others will already be stored in a buffer (835) awaiting the missing vector(s) so that the packet can be reassembled. A determination will be made as to whether any of the previously erroneous data vectors still have errors 865. If there are errors (865 Yes), any new valid vectors will be stored 835 and the errors will be analyzed 840. If there are no errors (865 No) then the packet is reassembled 890.

The embodiments described above for rotating the transmission of faulty data vectors can be used in multiple environments. The lane rotation could be used in parallel high-speed links, can be used in serial interconnects and could be used in digital interconnects. For example, the various embodiments described above could be used on a processor. The lane rotation could be used to transmit data between functions on a processor, between a processor and memory (on die or off die), between processors, or between a processor and periphery. The processor could be part of a computer or could be part of high-speed telecommunications equipment (e.g., store-and-forward devices).

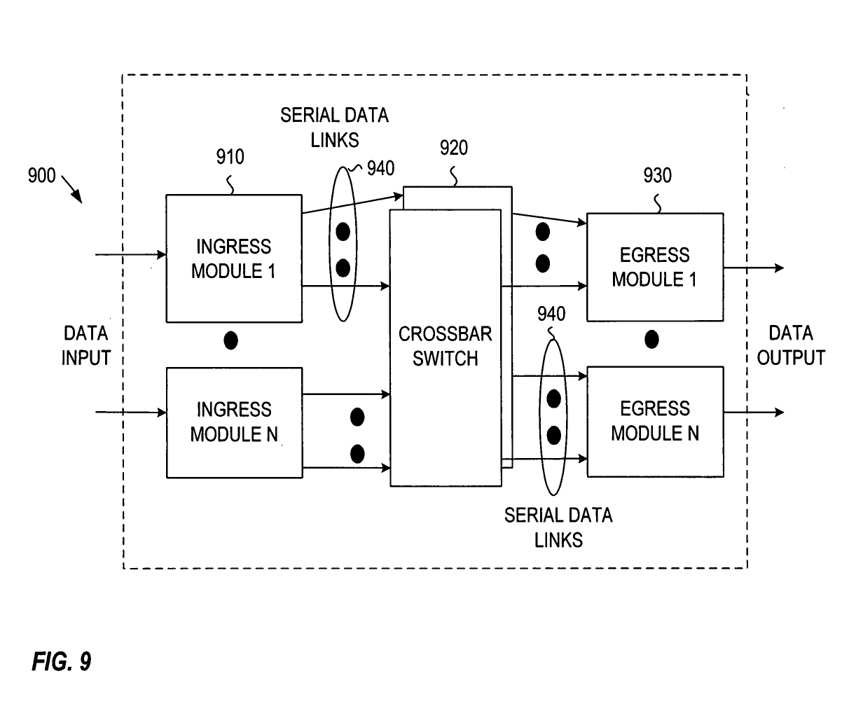

FIG. 9 illustrates an example system for transmitting data amongst various sources and destinations. The system may transmit the data using any number of protocols including Asynchronous Transfer Mode (ATM), Internet Protocol (IP), and Time Division Multiplexing (TDM). The data may be sent in variable length or fixed length blocks, such as cells, packets or frames. The communication lines used to transmit data may be fiber, copper, or other mediums. The system includes at least one store-and forward device 9005, such as a router or packet switch. The store-and-forward device 900 includes a plurality of ingress modules 910 connected through a crossbar 920 to a plurality of egress modules 130. The crossbar 920 may be electrical or optical. The ingress modules 910 and the egress modules 930 are typically two sides of a line card. The line cards may be Ethernet (e.g., Gigabit, 10 Base T), ATM, Fibre channel, Synchronous Optical Network (SONET), and Synchronous Digital Hierarchy (SDH), amongst others. A plurality of serial links 940 may be used to transmit data from the ingress modules 910 to the crossbar 920 and from the cross bar 920 to the egress modules 930. The serial links 940 may utilize the rotation/swapping embodiments. The combination of the crossbar 920 and the serial links 940 on each side thereof may also utilize the rotation/swapping embodiments described herein.

Although the various embodiments have been illustrated by reference to specific embodiments, it will be apparent that various changes and modifications may be made. Reference to “one embodiment” or “an embodiment” means that a particular feature, structure or characteristic described in connection with the embodiment is included in at least one embodiment. Thus, the appearances of the phrase “in one embodiment” or “in an embodiment” appearing in various places throughout the specification are not necessarily all referring to the same embodiment.

Different implementations may feature different combinations of hardware, firmware, and/or software. It may be possible to implement, for example, some or all components of various embodiments in software and/or firmware as well as hardware, as known in the art. Embodiments may be implemented in numerous types of hardware, software and firmware known in the art, for example, integrated circuits, including ASICs and other types known in the art, printed circuit broads, components, etc.

The various embodiments are intended to be protected broadly within the spirit and scope of the appended claims.

What is claimed:

1. An apparatus comprising:
a receiver to receive a data packet as a plurality of data vectors over an interconnect, wherein the interconnect includes a plurality of lanes;
an error detector to detect errors in the plurality of data vectors;
a buffer to store the data vectors received error free;
a processor to request a retransmission of the data packet if at least some subset of the plurality of data vectors have not been received error free, wherein the retransmission of the data packet includes at least a subset of the data vectors being transmitted on different lanes; and
an assembler to reconstruct the data packet once the plurality of data vectors making up the data packet are stored in said buffer, wherein the data packet can be reconstructed even if it was never sent correctly in a single transmission.

2. The apparatus of claim 1, wherein the retransmission includes the data vectors being rotated.

3. The apparatus of claim 1, wherein the retransmission includes the data vectors being rotated one lane.

4. The apparatus of claim 1, wherein the retransmission includes the data vectors being rotated based on lanes having errors.

5. The apparatus of claim 1, wherein the retransmission includes data vectors with errors and data vectors without errors swapping lanes.

6. The apparatus of claim 1, wherein said processor analyses the failed vectors and includes a rotation plan in the retransmission request.

7. The apparatus of claim 1, wherein said processor includes an accounting of the failures with the retransmission request.

8. The apparatus of claim 1, wherein the data vectors include a portion of the data packet and error detection bits.

9. The apparatus of claim 8, wherein the error detection bits are parity bits.

10. The apparatus of claim 8, wherein the error detection bits are cyclic redundancy codes (CRCs).

11. A method comprising:
receiving data vectors making up a packet over a plurality of lanes of an interconnect;
checking the data vectors for errors;
storing the data vectors received error free in a buffer;
requesting retransmission of the packet if at least some subset of the data vectors have not been received error free;
receiving the retransmission of the packet, wherein at least a subset of the data vectors making up the packet are received on different lanes; and
reassembling the packet once the plurality of data vectors making up the data packet are stored in said buffer, wherein the data packet can be reassembled even if it was never sent correctly in a single transmission.

12. The method of claim 11, wherein said requesting includes requesting the data vectors be rotated a predefined number of lanes.

13. The method of claim 11, wherein said requesting includes requesting the data vectors be rotated based on errors.

14. The method of claim 11, wherein said requesting includes requesting the data vectors with errors and the data vectors without errors swap lanes.

15. The method of claim 11, further comprising analyzing the failed vectors and generating a rotation plan based thereon.

16. The method of claim 11, further comprising transmitting an accounting of the failures with the retransmission request.

17. The method of claim 11, wherein the data vectors include a portion of the packet and error detection bits.

18. The method of claim 17, wherein the error detection bits are parity bits.

19. The method of claim 17, wherein the error detection bits are cyclic redundancy codes (CRCs).

20. A computer comprising:
a microprocessor die including:
a receiver to receive a data packet as a plurality of data vectors over an interconnect, wherein the interconnect includes a plurality of lanes; and
a processor to check the data vectors for errors, to store data packets having no errors, to request a retransmission of the packet if at least one data vector contains an error, and to reassemble the data packet once the data vectors making up the packet are stored, wherein the retransmission of the data packet includes at least a subset of the data vectors being transmitted on different lanes; and
an off-die memory device.

21. The computer of claim 20, wherein the data vectors are rotated to different lanes.

22. The computer of claim 20, wherein failed data vectors and error-free data vectors swap lanes.

23. A store and forward device comprising
a plurality of Ethernet cards to receive data from and transmit data to external sources; and
a switch to route data amongst the Ethernet cards; and
an interconnect to transmit packets between the switch and the Ethernet cards over a plurality of lanes, wherein if transmission of the packet fails retransmission of the packet includes the rotating of the data vectors to different lanes.

24. The device of claim 23, wherein the data vectors are rotated to different lanes.

25. The device of claim 23, wherein failed data vectors and error-free data vectors swap lanes.
